(19) United States
(12) Patent Application Publication
(10) Pub. No.: US 2014/0236405 A1
(43) Pub. Date: Aug. 21, 2014

(54) CONTROLLER FOR HYBRID VEHICLE

(71) Applicant: HONDA MOTOR CO., LTD., Minato-ku, Tokyo (JP)

(72) Inventor: Teruo Wakashiro, Sakura-shi (JP)

(21) Appl. No.: 13/880,625

(22) PCT Filed: Oct. 5, 2012
(86) PCT No.: PCT/JP2012/076044

§ 371 Date: Apr. 19, 2013

(30) Foreign Application Priority Data
Oct. 27, 2011 (JP) 2011-236063

(51) Int. Cl. B60L 15/20; B60L 11/02

(52) U.S. Cl. CPC B60L 15/20; B60L 11/02; Y10S 903/903
USPC 701/22; 903/903; 180/65.285

(57) ABSTRACT

A controller for hybrid vehicle includes: an electric generator that generates an electricity by a power of an internal combustion engine; an electric storage apparatus that is able to store the generated electricity of the electric generator; an electric motor that generates a vehicle driving power through at least the generated electricity of the electric generator or the stored electricity of the electric storage apparatus; a required-driving-force measurement section that measures a required driving force of a driver; a sound parameter setting section that sets a parameter relating to a sound which can be heard by the driver; and an electric generation control section that controls an electric generation output of the electric generator based on the required driving force, which is measured by the required-driving-force measurement section, and the parameter which is set by the sound parameter setting section.

### TECHNICAL FIELD OF THE INVENTION

The present invention relates to a controller for hybrid vehicle.

Priority is claimed on Japanese Patent Application No. 2011-236063, filed Oct. 27, 2011, the content of which is incorporated herein by reference.

### BACKGROUND ART

Hybrid electric automobiles that have a vehicle running motor and an electric generator which is driven by an engine have been known. In such automobiles, when the charging rate of a battery is large at the low vehicle speed at which engine noise relatively increases compared with the running sound (for example, road noise, wind noise, and the like) generated when a vehicle is running, by decreasing the rotation speed of the engine and the electric generation rate of the electric generator, the engine noise is decreased, and the gas exhausted from the engine is reduced. In contrast, when the charging rate of the battery is small, by decreasing only the rotation speed of the engine, the desired electric-generating capacity is secured, the engine noise is decreased, and the gas exhausted from the engine is reduced (for example, refer to Patent Document 1).

### PRIOR ART DOCUMENTS

### Patent Documents

Patent Document 1: Japanese Patent No. 3016343

### SUMMARY OF THE INVENTION

### Problems to be Solved by the Invention

However, in the hybrid electric automobiles according to the related art, when the vehicle speed is greater than or equal to a prescribed vehicle speed, it only deregulates the rotation speed of the engine and the electric generation rate of the electric generator. For example, in a case where running at the low vehicle speed is frequently repeated, there is a possibility that the remaining battery capacity continues to decrease. Hence, finally, in order to increase the remaining capacity of the battery, it is necessary to increase the electric generation rate of the electric generator and the rotation speed of the engine. As a result, a problem arises in that the engine noise is increased.

The present invention has been made in view of the above situation, and its object is to provide a controller for hybrid vehicle capable of improving a sense of comfort by suppressing noises at the time of driving a vehicle.

### Means for Solving the Problems

In order to achieve the object for solving the above-mentioned problem, the following configurations are adopted.

(1) According to an aspect of the present invention, a controller for hybrid vehicle includes: an electric generator that generates an electricity by a power of an internal combustion engine; an electric storage apparatus that is able to store the generated electricity of the electric generator; an electric motor that generates a vehicle driving power through at least the generated electricity of the electric generator or the stored electricity of the electric storage apparatus; a required-driving-force measurement section that measures a required driving force of a driver; a sound parameter setting section that sets a parameter relating to a sound which can be heard by the driver; and an electric generation control section that controls an electric generation output of the electric generator based on the required driving force, which is measured by the required-driving-force measurement section, and the parameter which is set by the sound parameter setting section.

(2) According to the aspect of (1), the controller for hybrid vehicle further includes an air volume setting value measurement section that measures an air volume setting value of an air adjustment apparatus, wherein the sound parameter setting section sets the parameter according to the air volume setting value which is measured by the air volume setting value measurement section, and wherein the electric generation control section performs control such that the electric generation output tends to increase as the parameter increases, and performs control such that the electric generation output tends to decrease as the parameter decreases.

(3) According to the aspect of (1) or (2), the controller for hybrid vehicle further includes a sound volume setting value measurement section that measures a sound volume setting value of an acoustic apparatus, wherein the sound parameter setting section sets the parameter according to the sound volume setting value which is measured by the sound volume setting value measurement section, and wherein the electric generation control section performs control such that the electric generation output tends to increase as the parameter increases, and performs control such that the electric generation output tends to decrease as the parameter decreases.

(4) According to the aspect of any one of (1) to (3), the controller for hybrid vehicle further includes a vehicle speed detection section that detects a vehicle speed, wherein the sound parameter setting section sets the parameter according to the vehicle speed which is detected by the vehicle speed detection section, and wherein the electric generation control section performs control such that the electric generation output tends to increase as the parameter increases, and performs control such that the electric generation output tends to decrease as the parameter decreases.

(5) According to the aspect of any one of (1) to (4), the controller for hybrid vehicle further includes a sound detection section that detects a sound volume of a sound in a vehicle interior, wherein the sound parameter setting section sets the parameter according to the volume of the sound which is detected by the sound detection section, and wherein the electric generation control section performs control such that the electric generation output tends to increase as the parameter increases, and performs control such that the electric generation output tends to decrease as the parameter decreases.

(6) According to another aspect of the present invention, a controller for hybrid vehicle includes: an electric generator that generates an electricity by a power of an internal combustion engine; an electric storage apparatus that is able to store the generated electricity of the electric generator; an electric motor that generates a vehicle driving power through at least the generated electricity of the electric generator or the stored electricity of the electric storage apparatus; an accelerator-pedal opening degree sensor that detects an accelerator-pedal opening degree; an air volume setting switch that outputs an air volume setting value of an air adjustment apparatus; a sound volume setting switch that outputs a sound volume setting value of an acoustic apparatus; a vehicle speed sensor that detects a vehicle speed and outputs a detection result thereof; a microphone that detects a sound volume of a vehicle interior sound and outputs a detection result thereof; a sound parameter setting section that sets a parameter relating to a sound which can be heard by the driver, based on at least any one of the air volume setting value, the sound volume setting value, the vehicle speed, and the sound volume of the vehicle interior sound; a remaining power amount measurement section that measures a remaining capacity of the electric storage apparatus; and an electric generation control section that controls an electric generation output of the electric generator, according to the accelerator-pedal opening degree which is detected by the accelerator-pedal opening degree sensor, the vehicle speed which is detected by the vehicle speed sensor, the parameter which is set by the sound parameter setting section, and the remaining capacity which is measured by the remaining power amount measurement section.

### Effect of the Invention

The controller for hybrid vehicle according to the aspect of (1) of the present invention controls the electric generation output of the electric generator according to the parameter relating to the sound, which can be heard by the driver, and the required driving force of the driver. Hence, it is possible to increase and decrease the electric generation output without causing discomfort to the driver due to the noise occurring when the internal combustion engine and the electric generator are driven.

With such a configuration, for example, it is possible to prevent the remaining capacity of the electric storage apparatus from excessively decreasing until it becomes necessary to drive the internal combustion engine and the electric generator in a condition which cause the uncomfortable noise for the driver, and it is possible to suppress the noise at the time of driving a vehicle and improve the sense of comfort of the driver.

In the controller for hybrid vehicle according to the aspect of (2) of the present invention, the parameter relating to the sound, which can be heard by the driver, is set according to the air volume setting value of the air adjustment apparatus. Hence, it is possible to increase and decrease the electric generation output without distracting the driver due to the noise occurring when the internal combustion engine and the electric generator are driven, according to the operation state of the air adjustment apparatus.

With such a configuration, it is possible to prevent the remaining capacity of the electric storage apparatus from excessively decreasing, and it is possible to suppress the noise at the time of driving a vehicle and improve the sense of comfort of the driver.

In the controller for hybrid vehicle according to the aspect of (3) of the present invention, the parameter relating to the sound, which can be heard by the driver, is set according to the sound volume setting value of the acoustic apparatus. Hence, it is possible to increase and decrease the electric generation output without distracting the driver due to the noise occurring when the internal combustion engine and the electric generator are driven, to the driver, according to the operation state of the acoustic apparatus.

With such a configuration, it is possible to prevent the remaining capacity of the electric storage apparatus from excessively decreasing, and it is possible to suppress the noise at the time of driving a vehicle and improve the sense of comfort of the driver.

In the controller for hybrid vehicle according to the aspect of (4) of the present invention, the parameter relating to the sound, which can be heard by the driver, is set according to the vehicle speed. Hence, it is possible to increase and decrease the electric generation output without distracting the driver due to the noise occurring when the internal combustion engine and the electric generator are driven, according to the size of the road noise or the wind noise increasing or decreasing relating to the vehicle speed.

With such a configuration, it is possible to prevent the remaining capacity of the electric storage apparatus from excessively decreasing, and it is possible to suppress the noise at the time of driving a vehicle and improve the sense of comfort of the driver.

In the controller for hybrid vehicle according to the aspect of (5) of the present invention, the parameter relating to the sound, which can be heard by the driver, is set according to the volume of the vehicle interior sound. Hence, it is possible to increase and decrease the electric generation output without distracting the driver due to the noise occurring when the internal combustion engine and the electric generator are driven.

With such a configuration, it is possible to prevent the remaining capacity of the electric storage apparatus from excessively decreasing, it is possible to suppress the noise at the time of driving a vehicle and improve the sense of comfort of the driver.

The controller for hybrid vehicle according to the aspect of (6) of the present invention controls the electric generation output of the electric generator according to the accelerator-pedal opening degree, the vehicle speed, the parameter relating to the sound which can be heard by the driver, and the remaining capacity. Hence, it is possible to increase and decrease the electric generation output without distracting the driver due to the noise occurring when the internal combustion engine and the electric generator are driven.

With such a configuration, for example, it is possible to prevent the remaining capacity of the electric storage apparatus from excessively decreasing until it becomes necessary to drive the internal combustion engine and the electric generator in a condition which cause the uncomfortable noise for the driver, and it is possible to suppress the noise at the time of driving a vehicle and improve the sense of comfort of the driver.

Furthermore, by measuring the parameter relating to the sound which can be heard by the driver based on multiple factors (that is, the air volume setting value, the sound volume setting value, the vehicle speed, and the sound volume of the vehicle interior sound), for example, by weighting the factors, it is possible to further minutely and appropriately correct the electric generation output.

### BRIEF DESCRIPTION OF DRAWINGS

FIG. 1 is a configuration diagram of a controller for hybrid vehicle according to an embodiment of the present invention.

FIG. 2A is a graph illustrating an example of a prescribed correspondence relationship between the air volume setting value and the volume of the sound which can be heard by the driver (the sound volume correlating with the air volume setting value) according to the embodiment of the present invention.

FIG. 2B is a graph illustrating an example of a prescribed correspondence relationship between the sound volume setting value and the volume of the sound which can be heard by the driver (the volume correlating with the sound volume setting value) according to the embodiment of the present invention.

FIG. 2C is a graph illustrating an example of a prescribed correspondence relationship between the detection result of the vehicle speed and the volume of the sound which can be heard by the driver (the volume correlating with the running sound such as the road noise and the wind noise caused by the vehicle speed) according to the embodiment of the present invention.

FIG. 2D is a graph illustrating an example of a prescribed correspondence relationship between the detection result of the sound volume of the vehicle interior sound (the volume of the sound collecting microphone) and the volume of the sound which can be heard by the driver (the volume correlating with the detection result of the volume of the sound collecting microphone) according to the embodiment of the present invention.

FIG. 3A is a map illustrating a prescribed correspondence relationship between the total sound function and the remaining capacity and the target electric-generating capacity according to the embodiment of the present invention.

FIG. 3B is a map illustrating a prescribed correspondence relationship between the total sound function, and the vehicle speed and the target number of rotations according to the embodiment of the present invention.

FIG. 4 is a flowchart illustrating an operation of the controller for hybrid vehicle according to the embodiment of the present invention, particularly, a process of determining the operation.

FIG. 5 is a flowchart illustrating a process of determining an electric generation operation shown in FIG. 4.

### DESCRIPTION OF EMBODIMENTS

Hereinafter, a controller for hybrid vehicle according to an embodiment of the present invention will be described referring to the accompanying drawings.

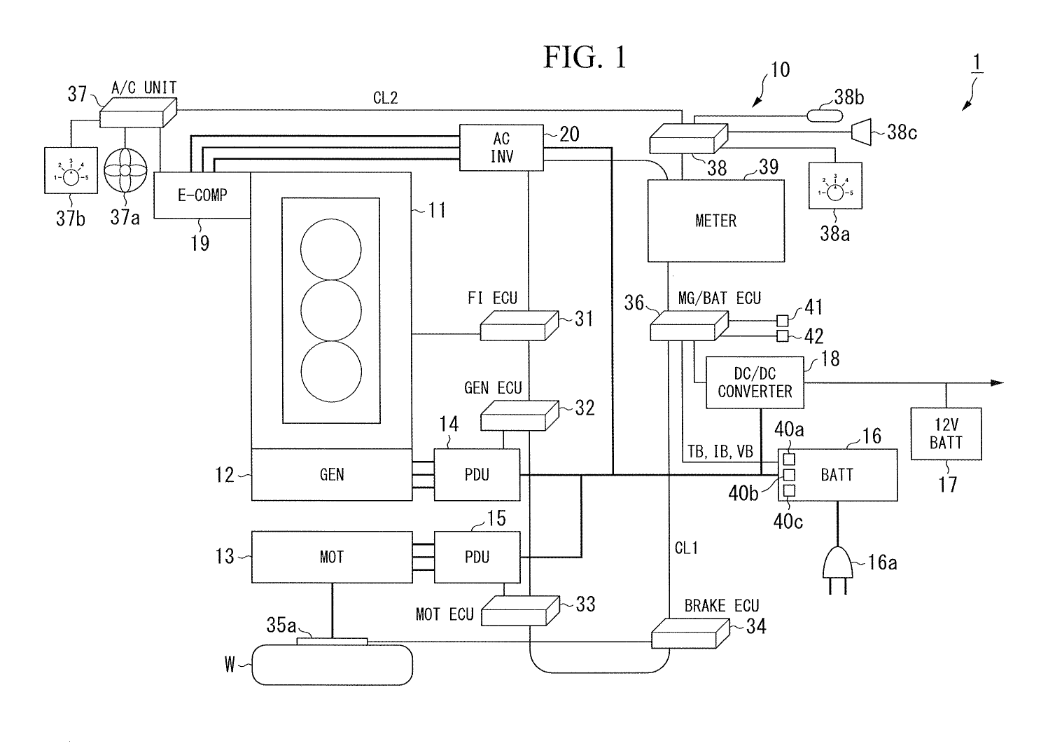

The controller for hybrid vehicle 10 according to the embodiment is mounted on, for example, a hybrid vehicle 1 shown in FIG. 1. The hybrid vehicle 1 is, for example, a series-type hybrid vehicle in which an electric generating motor (GEN) 12 is connected to a crank shaft (not shown in the drawing) of a three-cylinder internal combustion engine (ENG) 11 and a running motor (MOT) 13 is connected to driving wheels W.

The motors 12 and 13 are, for example, three-phase DC brushless motors or the like, and are respectively connected to the power drive units (PDU) 14 and 15 that control the motors 12 and 13.

Each of the PDUs 14 and 15 includes, for example, a PWM inverter (not shown in the drawing) having a bridge circuit, which is formed by using and bridging multiple switching elements, such as transistors, and using pulse width modulation (PWM).

In addition, the PDUs 14 and 15 are connected to a high-voltage (a voltage higher than low voltage 12V) battery (BATT) 16 such as a Li-ion battery.

The battery (electric storage apparatus) 16 includes, for example, an external charging plug 16a that can be connected to an external charging apparatus (not shown in the drawing). The battery 16 can be charged by the external charging apparatus through the external charging plug 16a.

For example, when an electric generating motor (electric generator) 12 generates an electricity by the power of the internal combustion engine 11, the PDU 14 converts the generated AC power, which is output from the electric generating motor 12, into DC power, and charges the battery 16 or supplies the electricity to the PDU 15 of the running motor (electric motor) 13.

Further, for example, at the time of driving the running motor 13, the PDU 15 converts the DC power, which is supplied from the PDU 14 of the electric generating motor 12 or the battery 16, into AC power, and supplies the electricity to the running motor 13.

On the other hand, for example, at the time of reducing the speed of the hybrid vehicle 1, when a driving force is transferred from the driving wheels W to the running motor 13, the running motor 13 functions as an electric generator so as to generate a so-called regenerative braking force, thereby recovering kinetic energy of the vehicle body as an electric energy.

The PDU 15 converts the generated (regenerated) AC power, which is output from the running motor 13, into a DC power at the time of electric generation of the running motor 13, thereby charging the battery 16.

The 12V battery (12VBATT) 17 of a low voltage for driving electric loads such as various auxiliaries is connected to a DC/DC converter 18. The DC/DC converter 18 is connected to the PDUs 14 and 15 and the battery 16.

The DC/DC converter 18 is able to charge the 12V battery 17 by stepping down the voltage between the terminals of the battery 16 or the terminals of each of the PDUs 14 and 15 to a prescribed voltage value.

It should be noted that the DC/DC converter 18 may be able to charge the battery 16 by stepping up the voltage between the terminals of the 12V battery 17 for example in a case where the remaining capacity SOC (State Of Charge) of the battery 16 decreases.

Further, an inverter (ACINV) 20 for an air adjustment apparatus that controls driving of an electric compressor (E-COMP) 19 is connected to the PDUs 14 and 15 and the battery 16.

The electric compressor 19 is driven by the AC power which is output from the inverter 20 for the air adjustment apparatus. The inverter 20 for the air adjustment apparatus converts the DC power, which is output from the PDUs 14 and 15 or the battery 16, into an AC power, and supplies the power to the electric compressor 19.

Further, the controller for hybrid vehicle 10 includes various ECUs (Electronic Control Unit: electronic control unit) formed of electronic circuits such as a CPU (Central Processing Unit). The various ECUs include a FI ECU 31, a GEN ECU 32, a MOT ECU 33, a BRAKE ECU 34, and an MG/BAT ECU 36 (a sound parameter setting section, an electric generation control section, or a remaining power amount measurement section).

The FI ECU 31 controls, for example, the fuel supply to the internal combustion engine 11, the ignition timing, and the like.

The FI ECU 31 electronically controls a throttle valve (not shown in the drawing) so as to open the valve by a degree of valve opening corresponding to the instruction of the MG/BAT ECU 36 by applying control current to an electronic actuator (not shown in the drawing) that drives the throttle valve, for example, at the time of EV run that is performed by the power of the running motor 13 driven by only the output of the battery 16, or at the time of controlling the internal combustion engine 11 according to the required driving force provided by a driver.

The GEN ECU 32 controls the electric generation of the electric generating motor 12 using the power of the internal combustion engine 11 by controlling the power conversion operation of the PDU 14.

The MOT ECU 33 controls the electric generation (regeneration) and the driving of the running motor 13 by controlling the power conversion operation of the PDU 15.

The power conversion operations of the PDUs 14 and 15 are controlled in response to pulses for ON/OFF driving the transistors of the PDUs 14 and 15 by for example the pulse width modulation (PWM) or the like. The amounts of operations of the motors 12 and 13 are controlled based on the duty ratios of the pulses, that is, the ratios of ON/OFF.

The BRAKE ECU 34 controls driving of a brake device 35a which is provided on the driving wheels W or the like, thereby performing the regeneration of the running motor 13 and the breaking of the driving wheels W in cooperation with each other.

The MG/BAT ECU 36 performs control to monitor and protect, for example, a high-voltage electrical equipment system (electrical equipment system to which a voltage higher than low voltage 12V is applied) which includes the battery 16, and performs control of the power conversion operations of the PDUs 14 and 15 and the DC-DC converter 18.

For example, the MG/BAT ECU 36 calculates the remaining capacity SOC of the battery 16 based on the respective detection signals of the voltage VB between the terminals of the battery 16 detected by a voltage sensor 40a, the current IB of the battery 16 detected by the current sensor 40b, and the temperature TB of the battery 16 detected by the temperature sensor 40c, and the operating time of the battery 16.

The remaining capacity SOC of the battery 16 is calculated and acquired by adding or subtracting the integral charge amount and the integral discharge amount to or from the remaining capacity SOC in a no-load state of the battery 16 without deterioration such as an initial state. Further, the remaining capacity SOC of the battery 16 is acquired by performing map search on a map, which represents a prescribed correlation between the remaining capacity SOC and the voltage (open-circuit voltage) in the no-load state of the battery 16 without deterioration such as the initial state, through an estimated open-circuit voltage of the current battery 16 which is estimated based on the voltage VB and the current IB and the temperature TB.

Further, a degree of deterioration of the battery 16 is calculated based on, for example, the operating time of the battery 16 as an energization period and a comparison result between a prescribed correlation between the remaining capacity SOC and the voltage VB of the battery 16 without deterioration such as the initial state and a correlation between the remaining capacity SOC and the voltage VB of the current battery 16.

Furthermore, the MG/BAT ECU 36 performs administration and control of all other ECUs 31 to 34, and controls the running state of the hybrid vehicle 1 and the driving states of the motors 12 and 13 and the internal combustion engine 11 in cooperation with the ECUs 31 to 34.

Hence, the detection signals which are output from various sensors and switches detecting the quantities of states of the hybrid vehicle 1 are input to the MG/BAT ECU 36.

The various sensors and switches input signals to, for example, an accelerator-pedal opening degree sensor (required-driving-force measurement section) 41 that detects the stroke amount (accelerator-pedal opening degree AP) of the accelerator pedal corresponding to the degree of depression of the accelerator pedal by the driver, a vehicle speed sensor (vehicle speed detection section) 42 that detects the speed (vehicle speed) VP of the hybrid vehicle 1, the voltage sensor 40a, the current sensor 40b, the temperature sensor 40c, and the MG/BAT ECU 36.

It should be noted that the ECUs 31 to 34 and the sensor types, which detect various states of the hybrid vehicle 1, are connected to a CAN (Controller Area Network) communication first line CL1 of the vehicle.

Further, an air adjustment apparatus unit (air adjustment apparatus) 37, an acoustic apparatus unit (acoustic apparatus) 38, and a meter 39 formed of meters and gauges, which display various states of the hybrid vehicle 1, are connected to a CAN (Controller Area Network) communication second line CL2 of which the communication speed is slower than that of the CAN communication first line CL1.

The controller for hybrid vehicle 10 according to the embodiment includes the above-mentioned configuration. Next, the operations of the controller for hybrid vehicle 10, particularly, the control operation of the MG/BAT ECU 36 will be described.

The MG/BAT ECU 36 is able to set a driving point (such as a point that represents appropriate combination between the torque and the number of rotations according to the output of the internal combustion engine 11) of the internal combustion engine 11 through fixed point driving or output follow-up driving, based on the signals of the detection results which are sequentially output from the accelerator-pedal opening degree sensor 41 and the vehicle speed sensor 42.

It should be noted that the fixed point driving of the internal combustion engine 11 is a driving point for continuously or intermittently driving the internal combustion engine 11 in a prescribed certain state such as a state where the BSFC (net fuel consumption rate: Brake Specific Fuel Consumption) of the internal combustion engine 11 is optimized or a state where the output of the internal combustion engine 11 is maximized.

In the fixed point driving, for example, when multiple driving points selectable in the prescribed certain state are included, an appropriate driving point (such as a driving point of the output most approximate to the required driving output or a driving point of the output larger than the required driving output) is selected.

Then, when the output of the internal combustion engine 11 at the selected driving point is smaller than the required driving output of the driver, the deficiency gets compensated by the output of the battery 16.

Further, the output follow-up driving of the internal combustion engine 11 is a driving point for driving the internal combustion engine 11 such that the engine follow up the output of the running motor 13 driven by the generated electricity of the electric generating motor 12 for example according to the required driving output corresponding to the depression operation of the accelerator pedal of the driver.

The MG/BAT ECU 36 controls the electric generation output of the electric generating motor 12 in response to the driving of the internal combustion engine 11 which is set based on the accelerator-pedal opening degree AP, the vehicle speed VP, the remaining capacity SOC of the battery 16, and the like.

The MG/BAT ECU 36 stores data such as a prescribed table created in advance so as to indicate, for example, a prescribed correspondence relationship between a first sound function (that is, the parameter correlating with the air volume setting value) LNVF of the sound, which can be heard by the driver, and the air volume setting value of the air adjustment apparatus unit 37 which is output from an air volume dial switch 37b (an air volume setting value measurement section or an air volume setting switch).

Then, the MG/BAT ECU 36 performs table search on a prescribed table based on the air volume setting value of the interior fan 37a which is output from the air volume dial switch 37b, thereby acquiring the first sound function LNVF of the sound, which can be heard by the driver, correlating with the air volume setting value.

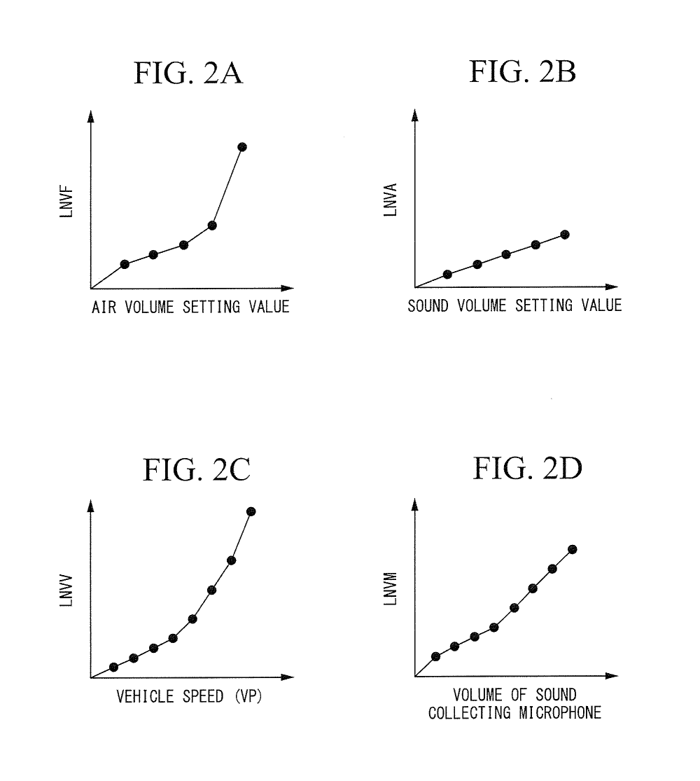

It should be noted that, in the prescribed table, for example, as shown in FIG. 2A, the first sound function LNVF correlating with the air volume setting value is set to be changed with a tendency to increase its value as the air volume setting value increases.

Further, the MG/BAT ECU 36 stores data such as a prescribed table created in advance so as to indicate, for example, a prescribed correspondence relationship between a second sound function (that is, the parameter correlating with the sound volume setting value) LNVA of the sound, which can be heard by the driver, and the sound volume setting value of the acoustic apparatus unit 38 which is output from a sound volume dial switch 38a (a sound volume setting value measurement section or a sound volume setting switch).

Then, the MG/BAT ECU 36 performs table search on a prescribed table based on the sound volume setting value which is output from the sound volume dial switch 38a, thereby acquiring the second sound function LNVA of the sound, which can be heard by the driver, correlating with the sound volume setting value.

It should be noted that, in the prescribed table, for example, as shown in FIG. 2B, the second sound function LNVA correlating with the sound volume setting value is set to be changed with a tendency to increase its value as the sound volume setting value increases.

Further, the MG/BAT ECU 36 stores data such as a prescribed table created in advance so as to indicate, for example, a prescribed correspondence relationship between a third sound function (that is, the parameter correlating with the running sound such as the road noise and the wind noise ascribed by the vehicle speed VP) LNVV of the sound, which can be heard by the driver, and the detection result of the vehicle speed VP which is output from a vehicle speed sensor 42.

Then, the MG/BAT ECU 36 performs table search on a prescribed table based on the detection result of the vehicle speed VP which is output from the vehicle speed sensor 42, thereby acquiring the third sound function LNVV of the sound, which can be heard by the driver, correlating with the detection result of the vehicle speed VP.

It should be noted that, in the prescribed table, for example, as shown in FIG. 2C, the third sound function LNVV correlating with the sound volume setting value is set to be changed with a tendency to increase its value as the detection result of the vehicle speed VP increases.

The MG/BAT ECU 36 stores data such as a prescribed table created in advance so as to indicate, for example, a prescribed correspondence relationship between a fourth sound function (that is, the parameter correlating with the detection result of the volume of the sound collecting microphone) LNVM of the sound, which can be heard by the driver, and the detection result of the sound volume (the volume of the sound collecting microphone) of the vehicle interior sound which is output from a sound collecting microphone 38b (a sound detection section or a microphone).

Then, the MG/BAT ECU 36 performs table search on a prescribed table based on the detection result of the volume of the sound collecting microphone which is output from the sound collecting microphone 38b, thereby acquiring the fourth sound function LNVM of the sound, which can be heard by the driver, correlating with the detection result of the volume of the sound collecting microphone.

It should be noted that, in the prescribed table, for example, as shown in FIG. 2D, the fourth sound function LNVM correlating with the detection result of the volume of the sound collecting microphone is set to be changed with a tendency to increase its value as the detection result of the volume of the sound collecting microphone increases.

Then, the MG/BAT ECU 36 performs control such that the electric generation output of the electric generating motor 12 is changed with a tendency to increase the output as the sound functions LNVF, LNVA, LNVV, and LNVM increase, and performs control such that the electric generation output of the electric generating motor 12 is changed with a tendency to decrease the output as the sound functions LNVF, LNVA, LNVV, and LNVM decrease.

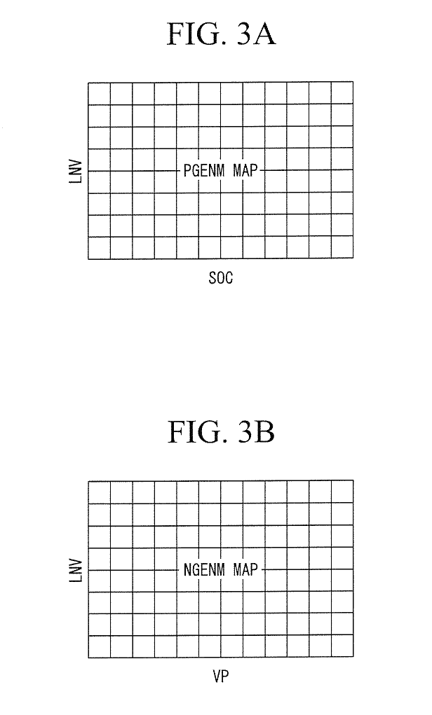

More specifically, the MG/BAT ECU 36 stores data such as a prescribed map created in advance so as to indicate, for example as shown in FIG. 3A, a prescribed correspondence relationship between a target electric-generating capacity PGENM of the electric generating motor 12, the remaining capacity SOC of the battery 16, and a total sound function LNV (=LNVF+LNVA+LNVV+LNVM) as the sum which can be obtained by adding the sound functions LNVF, LNVA, LNVV, and LNVM.

Then, the MG/BAT ECU 36 performs map search on a prescribed map based on the total sound function LNV and the remaining capacity SOC, thereby acquiring the target electric-generating capacity PGENM.

It should be noted that, in the prescribed map, for example, the target electric-generating capacity PGENM is set to be changed with a tendency to increase its value as the total sound function LNV increases or as the remaining capacity SOC decreases.

More specifically, the MG/BAT ECU 36 stores data such as a prescribed map created in advance so as to indicate, for example as shown in FIG. 3B, a prescribed correspondence relationship between a target number of rotations NGENM of the internal combustion engine 11, the detection result of the vehicle speed VP which is output from the vehicle speed sensor 42, and the total sound function LNV (=LNVF+LNVA+LNVV+LNVM) as the sum which can be obtained by adding the sound functions LNVF, LNVA, LNVV, and LNVM.

Then, the MG/BAT ECU 36 performs a map search on a prescribed map based on the total sound function LNV and the detection result of the vehicle speed VP, thereby acquiring the target number of rotations NGENM.

It should be noted that, in the prescribed map, for example, the target number of rotations NGENM is set to be changed with a tendency to increase its value as the total sound function LNV increases or as the detection result of the vehicle speed VP increases.

In addition, the MG/BAT ECU 36 controls the torque of the internal combustion engine 11 in cooperation with the FI ECU 31 so as to satisfy the target electric-generating capacity PGENM of the electric generating motor 12 and the target number of rotations NGENM of the internal combustion engine 11.

More specifically, the FI ECU 31 controls the torque of the internal combustion engine 11 by adjusting an ignition timing angle in the range from an advanced angle to a retarded angle in view of, for example, occurrence of accident fire, an increase in NOx, or the like.

Further, the FI ECU 31 controls the torque of the internal combustion engine 11 by changing the air amount or the fuel amount and adjusting the ratio of the air amount and the fuel amount in the range from lean to rich in view of an amount of purge for catalyst relative to occurrence of unburned gas absorbed by an adsorption agent.

Furthermore, for example, the internal combustion engine 11 and the electric generating motor 12 may be connected through a speed gear. In this case, the FI ECU 31 performs control so as to satisfy the target electric-generating capacity PGENM of the electric generating motor 12 by increasing or decreasing the target number of rotations NGENM of the internal combustion engine 11 so as to increase or decrease the amount of the output of the internal combustion engine 11, and thereby controls the torque of the internal combustion engine 11.

Hereinafter, the operation determination process of determining the driving mode of the hybrid vehicle 1 as the operation of the MG/BAT ECU 36 will be described.

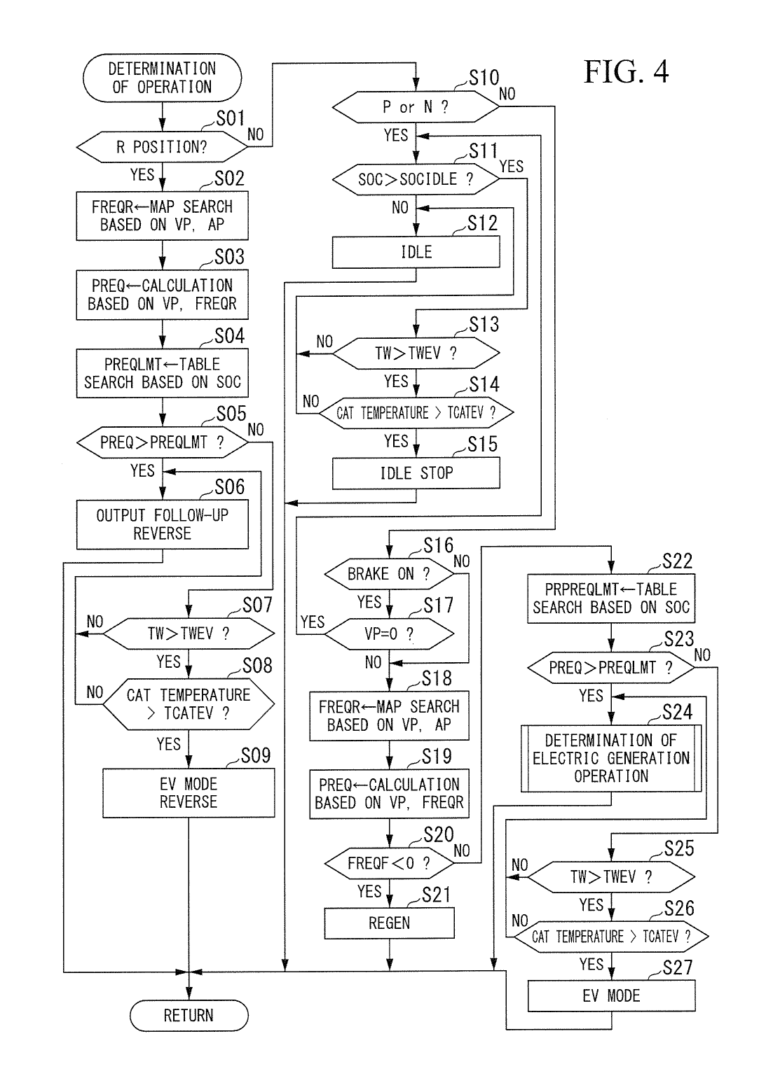

First, for example, in step S01 shown in FIG. 4, it is determined whether the shift operation position is the retreat R position.

If the determination result is “NO”, the process advances to step S10 to be described later.

In contrast, if the determination result is “YES”, the process advances to step S02.

Then, in step S02, a required driving force (for the backward movement) FREQR is calculated by the map search of the prescribed map based on the vehicle speed VP and the accelerator-pedal opening degree AR.

It should be noted the prescribed map represents a correspondence relationship between the vehicle speed VP, the accelerator-pedal opening degree AP, and the required driving force (for the backward movement) FREQR, and the map is created in advance.

Next, in step S03, the required driving output PREQ is calculated based on the vehicle speed VP and the required driving force (for the backward movement) FREQR.

Subsequently, in step S04, an EV mode allowable upper-limit driving output PREQLMT is calculated by the table search of the prescribed table based on the remaining capacity SOC of the battery 16.

It should be noted that the prescribed table represents a correspondence relationship between the remaining capacity SOC of the battery 16 and the allowable upper-limit driving output PREQLMT, and the table is created in advance.

Further, the EV mode allowable upper-limit driving output PREQLMT is an upper limit value of the driving output obtained when the running motor 13 is driven by using only the output of the battery 16, and is a value depending on the remaining capacity SOC of the battery 16.

Next, in step S05, it is determined whether the required driving output PREQ is higher than the allowable upper-limit driving output PREQLMT.

If the determination result is “YES”, the process advances to step S06.

In contrast, if the determination result is “NO”, the process advances to step S07 to be described later.

Then, in step S06, the output follow-up driving for the backward movement is set as the driving point of the internal combustion engine 11, and the process advances to “RETURN”.

Further, in step S07, it is determined whether or not a temperature (engine water temperature) TW of the cooling water of the internal combustion engine 11 is higher than a lower-limit water temperature TWEV for executing a prescribed EV run and idle stop.

If the determination result is ‘NO’, the process advances to step S06 mentioned above.

In contrast, if the determination result is ‘YES’, the process advances to step S08.

It should be noted that the lower-limit water temperature TWEV for executing the prescribed EV run and idle stop is a lower limit value of an engine water temperature TW for allowing executing the idle stop and the EV run in which running is performed by driving the running motor 13 depending on only the output of the battery 16.

Then, in step S08, it is determined whether or not a temperature (CAT temperature) of a catalyst for exhausted gas cleanup is higher than a lower-limit catalyst temperature TCATEV for executing the prescribed EV run and idle stop.

If the determination result is ‘NO’, the process advances to step S06 mentioned above.

In contrast, if the determination result is ‘YES’, the process advances to step S09.

It should be noted that the lower-limit catalyst temperature TCATEV for executing the prescribed EV run and idle stop is a lower limit value of the temperature (CAT temperature) of the catalyst for allowing executing the idle stop and the EV run in which running is performed by driving the running motor 13 depending on only the output of the battery 16.

Then, in step S09, as a driving mode for backward movement, the EV run, in which the driving of the internal combustion engine 11 is stopped and running is performed by driving the running motor 13 only depending on the output of the battery 16, is set, and then the process advances to “RETURN”.

Further, in step S10, it is determined whether the shift operation position is a parking P position or a neutral N position.

If the determination result is ‘NO’, the process advances to step S16 to be described later.

In contrast, if the determination result is ‘YES’, the process advances to step S11.

Then, in step S11, it is determined whether the remaining capacity SOC of the battery 16 is larger than a lower-limit SOCIDLE for executing the prescribed idle stop.

If the determination result is ‘NO’, the process advances to step S12.

In contrast, if the determination result is ‘YES’, the process advances to step S13 to be described later.

It should be note that the lower-limit SOCIDLE for executing the prescribed idle stop is a lower limit value of the remaining capacity SOC of the battery 16 for allowing executing the idle stop.

Then, in step S12, as the driving mode of the internal combustion engine 11, the idle driving of the internal combustion engine 11 is set, and the process advances to “RETURN”.

Further, in step S13, it is determined whether or not the temperature (engine water temperature) TW of the cooling water of the internal combustion engine 11 is higher than the lower-limit water temperature TWEV for executing the prescribed EV run and idle stop.

If the determination result is ‘NO’, the process advances to step S12 mentioned above.

In contrast, if the determination result is ‘YES’, the process advances to step S14.

Then, in step S14, it is determined whether or not a temperature (CAT temperature) of a catalyst for exhausted gas cleanup is higher than a lower-limit catalyst temperature TCATEV for executing the prescribed EV run and idle stop.

If the determination result is ‘NO’, the process advances to step S12 mentioned above.

In contrast, if the determination result is ‘YES’, the process advances to step S15.

Then, in step S15, as the driving mode of the internal combustion engine 11, the idle stop of the internal combustion engine 11 is set, and the process advances to “RETURN”.

Further, in step S16, it is determined whether or not a brake operation is performed.

If the determination result is ‘NO’, the process advances to step S18 to be described later.

In contrast, if the determination result is ‘YES’, the process advances to step S17.

Then, in step S17, it is determined whether or not the vehicle speed VP is zero.

If the determination result is ‘YES’, the process advances to step S11 mentioned above.

In contrast, if the determination result is ‘NO’, the process advances to step S18.

Then, in step S18, a required driving force (for the forward movement) FREQF is calculated by the map search of the prescribed map based on the vehicle speed VP and the accelerator-pedal opening degree AP.

It should be noted that the prescribed map represents a correspondence relationship between the vehicle speed VP, the accelerator-pedal opening degree AP, and the required driving force (for the forward movement) FREQF, and the map is created in advance.

Next, in step S19, the required driving output PREQ is calculated based on the vehicle speed VP and the required driving force (for the forward movement) FREQF.

Subsequently, in step S20, it is determined whether or not the required driving force (for the forward movement) FREQF is negative.

If the determination result is ‘YES’, the process advances to step S21. In step S21, as a driving mode for forward movement, the regeneration, in which the driving of the internal combustion engine 11 is stopped and the battery 16 is charged with the regenerated electric power generated by the regenerative braking of the running motor 13, is set, and the process advances to “RETURN”.

In contrast, if the determination result of step S20 is “NO”, the process advances to step S22.

Then, in step S22, the EV mode allowable upper-limit driving output PREQLMT is calculated by the table search of the prescribed table based on the remaining capacity SOC of the battery 16.

Next, in step S23, it is determined whether the required driving output PREQ is higher than the allowable upper-limit driving output PREQLMT.

If the determination result is ‘YES’, the process advances to step S24. In step S24, by performing a process of determining the electric generation operation to be described later, the electric generation operation is determined, and thereafter the process advances to “RETURN”.

In contrast, if the determination result is ‘NO’, the process advances to step S25.

Then, in step S25, it is determined whether or not a temperature (engine water temperature) TW of the cooling water of the internal combustion engine 11 is higher than a lower-limit water temperature TWEV for executing a prescribed EV run and idle stop.

If the determination result is ‘NO’, the process advances to step S24 mentioned above.

In contrast, if the determination result is ‘YES’, the process advances to step S26.

Then, in step S26, it is determined whether or not a temperature (CAT temperature) of a catalyst for exhausted gas cleanup is higher than a lower-limit catalyst temperature TCATEV for executing the prescribed EV run and idle stop.

If the determination result is ‘NO’, the process advances to step S24 mentioned above.

In contrast, if the determination result is ‘YES’, the process advances to step S27.

Then, in step S27, as the driving mode for forward movement, the EV run, in which driving the internal combustion engine 11 is stopped and running is performed by driving the running motor 13 only depending on the output of the battery 16, is set, and then the process advances to “RETURN”.

Hereinafter, the process of determining the electric generation operation in step S24 mentioned above will be described.

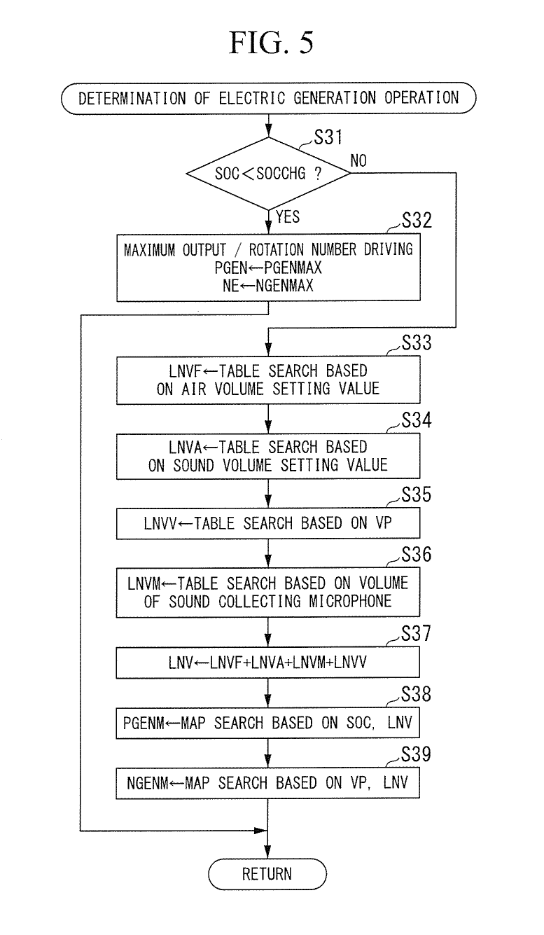

First, for example, in step S31 shown in FIG. 5, it is determined whether or not the remaining capacity SOC of the battery 16 is less than a remaining capacity for forced charging SOCCHG.

If the determination result is ‘YES’, the process advances to step S32.

In contrast, if the determination result is ‘NO’, the process advances to step S33.

It should be noted that the remaining capacity for forced charging SOCCHG is an upper limit value of the remaining capacity SOC of the battery 16 for which the forced charging for forcedly charging the battery 16 with the generated electricity of the electric generating motor 12 is necessary.

Then, in step S32, as the driving mode of the internal combustion engine 11, continuous fixed point driving, in which the output of the internal combustion engine 11 is maximized, is set, a prescribed maximum electric generation output PGENMAX is set to the electric generation output PGEN of the electric generating motor 12, a prescribed maximum number of rotations NGENMAX is set to the number of rotations NE of the internal combustion engine 11, and the process advances to “RETURN”.

Further, in step S33, the table search is performed on a prescribed table based on the air volume setting value of the interior fan 37a which is output from the air volume dial switch 37b, thereby acquiring the first sound function LNVF of the sound, which can be heard by the driver, correlating with the air volume setting value.

Next, in step S34, the table search is performed on a prescribed table based on the sound volume setting value which is output from the sound volume dial switch 38a, thereby acquiring the second sound function LNVA of the sound, which can be heard by the driver, correlating with the sound volume setting value.

Subsequently, in step S35, the table search is performed on a prescribed table based on the detection result of the vehicle speed VP which is output from the vehicle speed sensor 42, thereby acquiring the third sound function LNVV of the sound, which can be heard by the driver, correlating with the detection result of the vehicle speed VP.

Then, in step S36, the table search is performed on a prescribed table based on the detection result of the volume of the sound collecting microphone which is output from the sound collecting microphone 38b, thereby acquiring the fourth sound function LNVM of the sound, which can be heard by the driver, correlating with the detection result of the volume of the sound collecting microphone.

Next, in step S37, the total sound function LNV (=LNVF+LNVA+LNVV+LNVM) as the sum is calculated by adding the sound functions LNVF, LNVA, LNVV, and LNVM.

Subsequently, in step S38, the map search is performed on a prescribed map based on the total sound function LNV and the remaining capacity SOC, thereby acquiring the target electric-generating capacity PGENM.

Thereafter, in step S39, the map search is performed on a prescribed map based on the total sound function LNV and the detection result of the vehicle speed VP, thereby acquiring the target number of rotations NGENM, and the process advances to “RETURN”.

As described above, in the controller for hybrid vehicle 10 according to the embodiment, the target electric-generating capacity PGENM of the electric generating motor 12 and the target number of rotations NGENM of the internal combustion engine 11 are set based on the accelerator-pedal opening degree AP, the vehicle speed VP, the sound functions LNVF, LNVA, LNVV, and LNVM as the parameters relating to the sound, which can be heard by the driver, and the remaining capacity SOC. Hence, it is possible to increase or decrease the electric generation output without distracting the driver due to the noise occurring when the internal combustion engine 11 and the electric generating motor 12 are driven.

With such a configuration, for example, it is possible to prevent the remaining capacity SOC of the battery 16 from excessively decreasing until it becomes necessary to drive the internal combustion engine 11 and the electric generating motor 12 in a condition which cause the uncomfortable noise for the driver, and it is possible to suppress the noise at the time of driving a vehicle and improve the sense of comfort of the driver.

In particular, when the driving point of the internal combustion engine 11 is the fixed point driving, compared with the output follow-up driving in which the output of the internal combustion engine 11 follows up the depression operation of the accelerator pedal of the driver, there is a concern about an excessive decrease in the remaining capacity SOC of the battery 16 caused when the internal combustion engine 11 is driven in the prescribed certain state.

Whereas, by controlling the electric generation output of the electric generating motor 12 based on the parameter relating to the sound which can be heard by the driver, the remaining capacity SOC of the battery 16 is prevented from being excessively decreased, and thus it is possible to appropriately prevent the driving of the internal combustion engine 11 and the electric generating motor 12 which causes noise that gives a sense of discomfort to the driver.

Further, the first sound function LNVF of the sound, which can be heard by the driver, is acquired based on the air volume setting value of the interior fan 37a which is output from the air volume dial switch 37b. Hence, it is possible to increase and decrease the electric generation output without distracting the driver due to the noise occurring when the internal combustion engine 11 and the electric generating motor 12 are driven, according to the operation state of the interior fan 37a.

Furthermore, the second sound function LNVA of the sound, which can be heard by the driver, is acquired based on the sound volume setting value of the acoustic apparatus unit 38 which is output from the sound volume dial switch 38a. Hence, it is possible to increase and decrease the electric generation output without distracting the driver due to the noise occurring when the internal combustion engine 11 and the electric generating motor 12 are driven, according to the operation state of the acoustic apparatus unit 38.

Moreover, the third sound function LNVV of the sound, which can be heard by the driver, is acquired based on the vehicle speed VP. Hence, it is possible to increase and decrease the electric generation output without distracting the driver due to the noise occurring when the internal combustion engine 11 and the electric generating motor 12 are driven, according to the size of the road noise or the wind noise increasing or decreasing relating to the vehicle speed VP.

In addition, the fourth sound function LNVM of the sound, which can be heard by the driver, is acquired based on the detection result of the sound volume of the vehicle interior sound which is output from the sound collecting microphone 38b. Hence, it is possible to increase and decrease the electric generation output without distracting the driver due to the noise occurring when the internal combustion engine 11 and the electric generating motor 12 are driven.

It should be noted that, in the above-mentioned embodiment, the MG/BAT ECU 36 may set prescribed weighting on the sound functions LNVF, LNVA, LNVV, and LNVM when calculating the total sound function LNV (=LNVF+LNVA+LNVV+LNVM) by adding the sound functions LNVF, LNVA, LNVV, and LNVM.

Further, the MG/BAT ECU 36 may control the electric generation output of the electric generating motor 12 based on at least any one of the sound functions LNVF, LNVA, LNVV, and LNVM.

In addition, in the above-mentioned embodiment, the electric generation output of the electric generating motor 12 is controlled based on the accelerator-pedal opening degree AP, the vehicle speed VP, the sound functions LNVF, LNVA, LNVV, and LNVM as the parameters relating to the sound, which can be heard by the driver, and the remaining capacity SOC. However, the invention is not limited to this. For example, the electric generation output of the electric generating motor 12, which is controlled based on the accelerator-pedal opening degree AP and the vehicle speed VP, may be corrected based on the sound functions LNVF, LNVA, LNVV, and LNVM as the parameters relating to the sound, which can be heard by the driver. In such a manner, it will be possible to increase and decrease the electric generation output without distracting the driver due to the noise occurring when the internal combustion engine 11 and the electric generating motor 12 are driven.

It should be noted that, in the above-mentioned embodiment, the running motor 13 may be connected to either the front wheels or the rear wheels.

Further, in the above-mentioned embodiment, as the running motor 13, two running motors 13 of the running motor 13, which is connected to the front wheels, and the running motor 13, which is connected to the rear wheels, may be provided.

Furthermore, in the above-mentioned embodiment, the hybrid vehicle 1 is not limited to the series type, and may be, for example, the hybrid vehicle 1 having both functions of the series and parallel types.

### Reference Signs List

1. HYBRID VEHICLE

10: CONTROLLER FOR HYBRID VEHICLE

11: INTERNAL COMBUSTION ENGINE

12: ELECTRIC GENERATING MOTOR (ELECTRIC GENERATOR)

13: RUNNING MOTOR (ELECTRIC MOTOR)

16: BATTERY (ELECTRIC STORAGE APPARATUS)

36: MG/BAT ECU (SOUND PARAMETER SETTING SECTION, ELECTRIC GENERATION CONTROL SECTION, REMAINING POWER AMOUNT MEASUREMENT SECTION)

37: AIR ADJUSTMENT APPARATUS UNIT (AIR ADJUSTMENT APPARATUS)

37b: AIR VOLUME DIAL SWITCH (AIR VOLUME SETTING VALUE MEASUREMENT SECTION, AIR VOLUME SETTING SWITCH)

38: ACOUSTIC APPARATUS UNIT (ACOUSTIC APPARATUS)

38a: SOUND VOLUME DIAL SWITCH (SOUND VOLUME SETTING VALUE MEASUREMENT SECTION, SOUND VOLUME SETTING SWITCH)

38b: SOUND COLLECTING MICROPHONE (SOUND DETECTION SECTION, MICROPHONE)

41: ACCELERATOR-PEDAL OPENING DEGREE SENSOR (REQUIRED-DRIVING-FORCE MEASUREMENT SECTION)

42: VEHICLE SPEED SENSOR (VEHICLE SPEED DETECTION SECTION)

STEPS S33 TO S37: SOUND PARAMETER SETTING SECTION

STEPS S38 AND S39: ELECTRIC GENERATION CONTROL SECTION

1. A controller for hybrid vehicle comprising:
an electric generator that generates an electricity by a power of an internal combustion engine;
an electric storage apparatus that is able to store the generated electricity of the electric generator;
an electric motor that generates a vehicle driving power through at least the generated electricity of the electric generator or the stored electricity of the electric storage apparatus;
a required-driving-force measurement section that measures a required driving force of a driver;
a sound parameter setting section that sets a parameter relating to a sound which can be heard by the driver; and
an electric generation control section that controls an electric generation output of the electric generator based on the required driving force, which is measured by the required-driving-force measurement section, and the parameter which is set by the sound parameter setting section.

2. The controller for hybrid vehicle according to claim 1, further comprising,
an air volume setting value measurement section that measures an air volume setting value of an air adjustment apparatus,
wherein the sound parameter setting section sets the parameter according to the air volume setting value which is measured by the air volume setting value measurement section, and
wherein the electric generation control section performs control such that the electric generation output tends to increase as the parameter increases, and performs control such that the electric generation output tends to decrease as the parameter decreases.

3. The controller for hybrid vehicle according to claim 1, further comprising,
a sound volume setting value measurement section that measures a sound volume setting value of an acoustic apparatus,
wherein the sound parameter setting section sets the parameter according to the sound volume setting value which is measured by the sound volume setting value measurement section, and
wherein the electric generation control section performs control such that the electric generation output tends to increase as the parameter increases, and performs control such that the electric generation output tends to decrease as the parameter decreases.

4. The controller for hybrid vehicle according to claim 1, further comprising,
a vehicle speed detection section that detects a vehicle speed,
wherein the sound parameter setting section sets the parameter according to the vehicle speed which is detected by the vehicle speed detection section, and
wherein the electric generation control section performs control such that the electric generation output tends to increase as the parameter increases, and performs control such that the electric generation output tends to decrease as the parameter decreases.

5. The controller for hybrid vehicle according to claim 1, further comprising,
a sound detection section that detects a sound volume of a sound in a vehicle interior,
wherein the sound parameter setting section sets the parameter according to the volume of the sound which is detected by the sound detection section, and
wherein the electric generation control section performs control such that the electric generation output tends to increase as the parameter increases, and performs control such that the electric generation output tends to decrease as the parameter decreases.

6. A controller for hybrid vehicle comprising:
an electric generator that generates an electricity by a power of an internal combustion engine;
an electric storage apparatus that is able to store the generated electricity of the electric generator;
an electric motor that generates a vehicle driving power through at least the generated electricity of the electric generator or the stored electricity of the electric storage apparatus;
an accelerator-pedal opening degree sensor that detects an accelerator-pedal opening degree;
an air volume setting switch that outputs an air volume setting value of an air adjustment apparatus;
a sound volume setting switch that outputs a sound volume setting value of an acoustic apparatus;
a vehicle speed sensor that detects a vehicle speed and outputs a detection result thereof;
a microphone that detects a sound volume of a vehicle interior sound and outputs a detection result thereof;
a sound parameter setting section that sets a parameter relating to a sound which can be heard by the driver, based on at least any one of the air volume setting value, the sound volume setting value, the vehicle speed, and the sound volume of the vehicle interior sound;
a remaining power amount measurement section that measures a remaining capacity of the electric storage apparatus; and
an electric generation control section that controls an electric generation output of the electric generator, according to the accelerator-pedal opening degree which is detected by the accelerator-pedal opening degree sensor, the vehicle speed which is detected by the vehicle speed sensor, the parameter which is set by the sound parameter setting section, and the remaining capacity which is measured by the remaining power amount measurement section.
